(19) United States
(12) Patent Application Publication
(10) Pub. No.: US 2018/0032169 A1
(43) Pub. Date: Feb. 1, 2018

(54) SILVER NANOWIRE TOUCH SENSOR COMPONENT

(71) Applicant: INTEL CORPORATION, Santa Clara, CA (US)

(72) Inventors: Dong Yeung Kwak, San Jose, CA (US); Ramon C. Cancel Olmo, Hillsboro, OR (US); Jue Li, Shanghai (CN)

(21) Appl. No.: 14/915,148

(22) PCT Filed: Mar. 26, 2015
(86) PCT No.: PCT/CN2015/075119

§ 371 Date: Feb. 26, 2016

(51) Int. Cl. G06F 3/044

(52) U.S. Cl. CPC G06F 3/044; G06F 2203/04103; G06F 2203/04112

(57) ABSTRACT

Apparatus and/or methods may provide a substrate and a sensor pattern formed on the substrate based on a visibility level for a touch sensor application. The sensor pattern may include a specified inter-pattern spacing and a specified pattern width to provide the visibility level. For example, the specified inter-pattern spacing may be between about 1 μm and about 60 μm and the specified pattern width may be between about 1 μm and about 250 μm to provide the visibility level for a touch screen sensor application. The sensor pattern may be included in a periodical repeat of sensor patterns. The sensor pattern may include silver nanowire networks, and may not to be observable by visual inspection.

### CROSS-REFERENCE WITH RELATED APPLICATIONS

This application is a U.S. National Phase Patent Application which claims benefit to International Patent Application No. PCT/CN2015/075119 filed Mar. 26, 2015.

### TECHNICAL FIELD

Embodiments generally relate to a touch sensor component. More particularly, embodiments relate to a touch sensor component including a silver nanowire sensor pattern that is formed utilizing a fabrication rule based on a visibility level.

### BACKGROUND

Various materials have been evaluated for use as electrodes in touch sensor applications, including indium tin oxide (ITO) film, ITO one glass solution (OGS), metal mesh (MM) (e.g., silver, copper, etc.), carbon nanotube (CNT), graphene, silver nanowire (SNW), and so on. While ITO materials may be implemented in touch screen sensor applications due to relatively good visibility levels and sheet resistivity (e.g., about 100 Ω/sq to 150 Ω/sq), ITO materials may have relatively low flexibility, relatively low availability, relatively high cost, relatively high brittleness, and/or may require relatively onerous fabrication processes. CNT and graphene materials may not yet be usable as stand-alone electrode materials. In addition, MM and SNW materials may have relatively higher visibility levels compared to ITO materials. Thus, the use of SNW materials as electrodes in touch screen sensor applications may be limited since the electrodes are observable (e.g., identified, recognized, etc.) by an individual that looks at a touch screen under ambient lighting conditions without specialized optical aids.

### BRIEF DESCRIPTION OF THE DRAWINGS

The various advantages of embodiments will become apparent to one skilled in the art by reading the following specification and appended claims, and by referencing the following drawings, in which:

FIGS. 1A and 1B are examples of a touch sensor component according to an embodiment;

FIGS. 2A and 2B are examples of a touch sensor structure according to an embodiment;

FIGS. 3A and 3B are examples of a computing device including a touch sensor component according to an embodiment;

FIGS. 4A to 4C are examples of an approach to determine a fabrication rule for a touch sensor component according to an embodiment;

FIG. 5 is a flowchart of an example of a method to form and/or to implement a touch sensor component according to an embodiment; and

FIG. 6 is a block diagram of an example of a computing device according to an embodiment.

### DETAILED DESCRIPTION

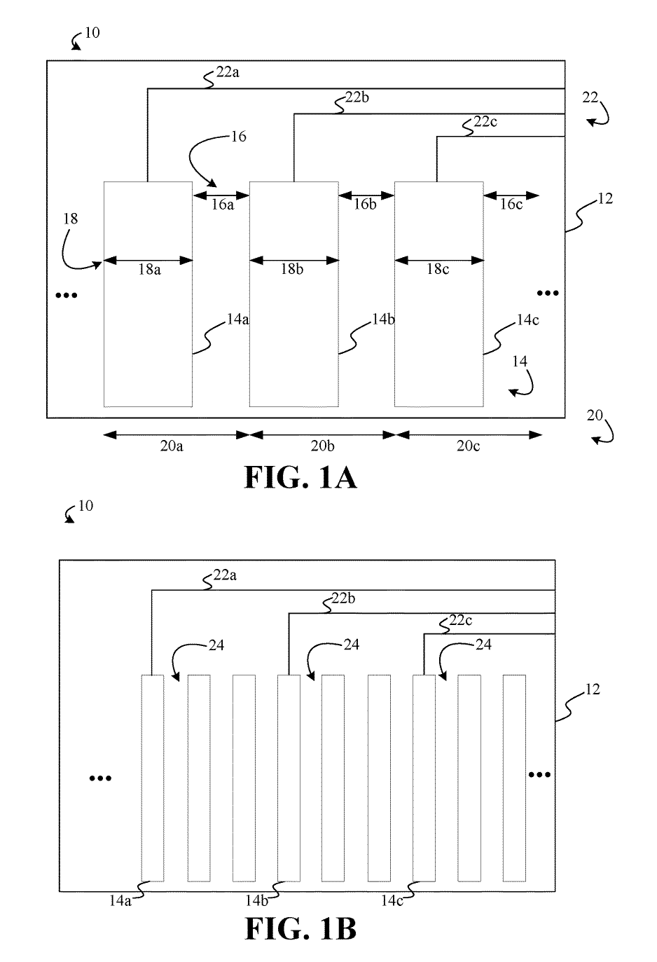

FIGS. 1A and 1B illustrate an example of a touch sensor component 10 according to an embodiment. The touch sensor component 10 may be utilized to determine a location of an interaction between a device (e.g., via a touch screen, a touch pad, etc.) and a conductive object, such as a finger, a stylus, and so on. For example, the interaction may include a finger that hovers over a touch screen to select or manipulate content being displayed by the touch screen. Thus, the touch sensor component 10 may be implemented in a computing platform such as a desktop computer, a notebook computer, a tablet computer, a convertible tablet, a personal digital assistant (PDA), a mobile Internet device (MID), a media player, a smart phone, a smart televisions (TV), a radio, an infotainment system, etc., or any combination thereof.

The touch sensor component 10 may be included in a touch sensor structure such as a glass-only structure, a film-only structure, a glass-and-film structure, an on-cell structure, and so on. The glass-only structure may include, for example, a cover-glass with one glass sensor (GG) structure, which may include a cover-glass layer followed by a transmit and receive electrode layer, and a sensor-glass layer. The GG structure may also include, for example, a cover-glass layer followed by a receive electrode layer, a sensor-glass layer, and a transmit electrode layer. The glass-only structure may include, for example, a one glass solution (OGS) structure, which may include a cover-glass layer followed by a transmit and receive electrode layer.

The film-only structure may include, for example, a cover-glass with two sensor film (GFF) structure, which may include a cover-glass layer followed by a receive electrode layer, a first film layer, a transmit electrode layer, and a second film layer. The film-only structure may also include, for example, a cover-glass with one electrode layer on each side of a sensor film (GF2) structure, which may include a cover-glass layer followed by a receive electrode layer, a film layer, and a transmit electrode layer. The on-cell structure may include, for example, a touch sensor structure formed on a display module, such as a liquid crystal display (LCD), an organic light-emitting diode (OLED), and so on. In one example, the on-cell structure may include a touch sensor structure formed on a color-filter glass of an LCD, on an encapsulation glass of an OLED, and so on.

The illustrated touch sensor component 10 includes a substrate 12, which may function as a cover-glass in a touch sensor structure, a sensor-glass in a touch sensor structure, a sensor film in a touch sensor structure, and so on. Accordingly, the substrate 12 may include a glass material for touch screen sensor applications. The glass material may include quartz glass, non-alkali glass, crystallized transparent glass, soda-lime silica glass, chemically strengthened glass, heat strengthened glass, ion-exchange strengthened glass (e.g., potassium ion, alumino-silica, etc.), plastic glass (e.g., isobutyl methacrylate, etc.), sapphire glass, and so on.

The substrate 12 may also include a polymer material for touch screen sensor applications. The polymer material may include polyethylene terephthalate (PET), cyclic olefin polymer (COP), cyclic olefin copolymer (COCP), polyimide (PI), polycarbonate (PC), triacetyl cellulose (TAC), and so on. In addition, a thickness of the substrate 12 may be controlled. For example, the thickness of the substrate 12 may be between about 50 μm and about 100 μm for a film implementation and between about 0.1 mm and about 0.4 mm for a glass implementation, although the substrate 12 may be formed including a smaller thickness or larger thickness for a film or a glass implementation.

The illustrated touch sensor component 10 further includes sensor patterns 14 (14a, 14b, 14c) formed of metal nanowires. For example, the sensor patterns 14 may be formed of SNW networks. SNWs are readily commercially obtained or fabricated to any specified dimension, with at least one dimension (e.g., diameter) in the nanometer size range. For example, 500 mg of SNWs may be obtained (ACS Material®, Medford Mass.) at a stock concentration of about 20 mg/ml to about 55 mg/ml having an average diameter of about 40 nm to about 400 nm and an average length of about 20 μm to about 200 μm, with silver purity of about 99.5%. SNWs may also be fabricated by, for example, deposition (e.g., vapor deposition, electrodeposition), solution-phase synthesis, and so on. Thus, SNWs may be fabricated with a diameter less than about 40 nm (e.g., about 20 nm, about 10 nm, etc.).

A thickness of the sensor patterns 14 may be controlled by, for example, filtering different dispersion volumes to provide desired deposited masses, using specific fabrication processes and/or parameters thereof, and so on. For example, the thickness of the sensor patterns 14 may be between about 15 nm (e.g., evaporation process), or less (e.g., about 10 nm), and about 600 nm (e.g., heat and pressure using cellulose membrane and vacuum filtration), or more (e.g., about 1 μm). In one example, a film having a mass per unit area (M/A) of about 47 mg/m² (thickness of about 107 nm) may include a sheet resistivity of about 13 Ω/sq and an optical transmittance (e.g., transparency) of about 85%. Thus, the sensor patterns 14 may be formed on the substrate 12 for use as electrodes in touch sensor applications such as touch screen sensor applications.

Generally, capacitance detected by using the touch sensor component 10 may change as a function of proximity or movement of a conductive object to the touch sensor component 10, wherein the sensor patterns 14 may be utilized to detect changes in capacitance. Accordingly, the touch sensor component 10 may be utilized in a capacitance touch sensor implementation. For example, the touch sensor component 10 may be utilized in a surface capacitance touch sensor implementation, a self-capacitance touch sensor implementation, a mutual capacitance touch sensor implementation, and so on.

The sensor patterns 14 may have, for example, an optical transmittance (e.g., transparency) between about 85% and about 93%, and a sheet resistivity between about 10 ohm/sq and about 60 ohm/sq, or more (e.g., 250 Ω/sq). The sensor patterns 14 may also have a relatively higher flexibility (e.g. strechability, foldability, etc.) and/or a relatively low brittleness compared to, e.g., ITO films and ITO OGS. For example, the sensor patterns 14 may be subjected to a repeated bending angle between about 1 degree and about 160 degrees, or more, with minimized variation (e.g., less than about 2%) from its original state. Moreover, the sensor patterns 14 may include a haze of less than about 0.80%, and a color index of less than about 1.

As discussed below, a relatively high visibility level may be caused by differences in reflectance between a surface of the substrate 12 and a surface of the sensor patterns 14. In addition, a relatively high visibility level may be caused by scattering of light from an edge of the sensor patterns 14. Thus, the sensor patterns 14 may be formed using a fabrication rule based on and/or to minimize visibility level. For example, the sensor patterns 14 may be formed utilizing a fabrication rule based on a visibility level, wherein the fabrication rule may be a function of and/or may specify an inter-pattern spacing and a pattern width to provide a specific visibility level for use in a specific touch sensor application. In one example, the fabrication rule may specify an inter-pattern spacing between about 1 μm and about 60 μm, and a pattern width between about 1 μm and 250 μm, to provide a specific visibility level that is suitable for a touch screen sensor application.

In the illustrated example, spaces 16 (16a, 16b, 16c) located between the sensor patterns 14 physically separate the patterns 14 from one another and/or minimize a visibility level of the sensor patterns 14. The spaces 16 may include a size of about 60 μm between two adjacent patterns 14, a size of about 30 μm between two adjacent patterns 14, a size of about 15 μm between two adjacent patterns 14, a size of about 1 μm or less between two adjacent patterns 14, and so on. For example, a direct printing technique (e.g., screen printing, ink-jet printing, etc.) may provide an inter-pattern spacing having a size of about 10 μm, a photolithography technique may provide an inter-pattern spacing having a size of about 1 μm, and so on. Thus, for example, the spaces 16a, 16b, 16c may each include a size of about 30 μm between adjacent sensor patterns 14a, 14b, 14c, respectively.

In addition, the sensor patterns 14 include widths 18 (18a, 18b, 18c) to minimize a visibility level of the sensor patters 14. The widths 18 may include a size of about 250 μm, a size of about 100 μm, a size of about 50 μm, a size of about 25 μm or less, and so on. For example, the widths 18a, 18b, 18c may each include a size of about 100 μm. Thus, a fabrication rule may be provided that is a function of and/or that specifies inter-pattern spacing and pattern width for a specific visibility level.

The fabrication rule may also be a function of and/or may specify pattern periodicy. The pattern periodicy may define a combination of visibility variables, such as specified inter-pattern space, pattern width, pitch, etc., to provide a periodical repeat of sensor patterns. For example, the fabrication rule may specify a periodicy including a period of at least one sensor pattern. Thus, a pitch 20 (20a, 20b, 20c) may be the same for a set of sensor patterns (e.g., across substantially an entire open area of a touch screen) that repeat by a period of 1 sensor pattern when the size of the spaces 16a, 16b, 16c is the same and the size of the widths 18a, 18b, 18c is the same. Notably, regularity (periodical repeat) of sensor patterns including the same inter-pattern spacing and pattern width, together with specified inter-pattern spacing between about 1 μm and about 60 μm and pattern width between about 1 μm and 250 μm, may maximize visibility level advantages (e.g., minimize visibility level).

In another example, the fabrication rule may specify a periodicy including a period of at least 2 sensor patterns. For example, the size of the space 16a and the size of the width 18a of the pitch 20a may be the same as the size of the space 16c and the size of the width 18c of the pitch 20c, which may be different than the size of space 16b and the size of the width 18b of the pitch 20b. In this regard, the sensor patterns 14a, 14b may be first members of the period of 2 sensor patters, while the sensor pattern 14c and a next adjacent sensor pattern may be second members of the period of 2 sensor pattern. In a further example, a period of 3 sensor patterns may be provided by specifying the size of the spaces 16a, 16b, 16c (either same or different sizes), the size of the widths 18a, 18b, 18c (either same or different sizes), and repeating the configuration across substantially an entire open area of a touch screen for all sensor patterns (e.g., all transmit patterns at one layer of a sensor structure).

The fabrication rule may further be a function of and/or may specify an average of pitch (and/or variables thereof). For example, the fabrication rule may specify an average of two or more inter-pattern spacing sizes and/or two or more pattern width sizes to specify an average inter-pattern spacing, an average pattern width, and/or an average pitch to determine and/or provide a touch sensor including an average visibility level. As discussed below, a pitch of about 160 μm (e.g., about 60 μm inter-pattern spacing and about 100 μm pattern width) having a visibility level of about 3 may be averaged with a pitch of about 130 μm (e.g., 30 μm inter-pattern spacing and about 100 p.m pattern width) having a visibility level of about 1 to specify an average pitch of about 145 μm (e.g., about 90 μm inter-pattern space and about 100 μm pattern width) with an average visibility level of about 2, which may be utilized to form a touch screen sensor.

The fabrication rule may also be a function of and/or may specify other factors such as sheet resistance, optical transmittance, flexibility, haze, color index, electric field uniformity, and so on. For example, a gradual and/or minimized change in electric field may dictate that changes in inter-pattern spacing, pattern width, periodicy, pitch, etc., be omitted, minimized and/or gradually implemented.

In the illustrated example, the touch sensor component 10 further includes channels 22 (22a, 22b, 22c) to couple the sensor patterns 14 with platform hardware. For example, the channel 22a couples the sensor pattern 14a with platform hardware, the channel 22b couples the sensor pattern 14b with platform hardware, and the channel 22c couples the sensor pattern 14c with platform hardware, wherein the platform hardware may be the same or different hardware. The channels 22 may form a bus bar, which may be formed on the substrate 12.

In one example, the channels 22 may include conductive tracks (e.g., copper, etc.) that couple the sensor patterns 14 with a printed circuit board (PCB). In another example, one or more of the sensor patterns 14 may be coupled with a voltage driver to drive a voltage across the one or more of the sensor patterns 14 (e.g., drive electrode, transmit electrode, etc.). In a further example, one or more of the sensor patterns 14 may be connected with an A/D converter to convert sense signals to digital representations thereof (e.g., sense electrode, receive electrode, etc.).

In addition, one or more of the sensor patterns 14 may be coupled with a processor (e.g., digital signal processor, central processing unit, etc.) to determine a location corresponding to an interaction based on the sense signals. The sensor patterns 14 may be directly coupled with the channels 22. The sensor patterns 14 may also be indirectly coupled with the channels 22 via electrical contacts formed from, e.g., epoxy silver paste and conjugated polymer.

As illustrated in FIG. 1B, the touch sensor component 10 may further include dummy patterns 24. The dummy patterns 24 may be formed of the same or different material as the sensor patterns 14. Accordingly, the dummy patterns 24 may include SNW networks. The dummy patterns 24 may be fabricated using the same or different processes implemented to fabricate one or more of the sensor patterns 14. In addition, the dummy patterns 24 may be fabricated at the same time or at a different time as when one or more of the sensor patterns 14 are fabricated.

The dummy patterns 24 may reduce capacitance between adjacent sensor patterns 14. In addition, the dummy patterns 24 may maintain the sensor patterns 14 spaced apart from each other (e.g., minimize physical contact between patterns). In the illustrated example, the dummy patterns 24 are formed using the same fabrication rule as the sensor patterns 14, such that the inter-pattern spacing and the pattern widths are the same size for the sensor patterns 14 and the dummy patterns 24.

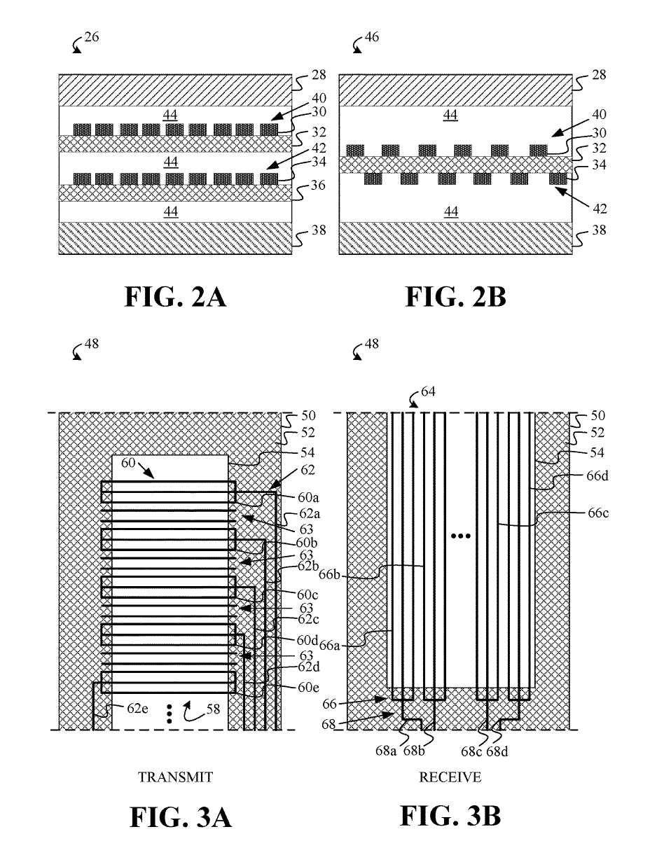

Turning now to FIGS. 2A and 2B, examples of touch sensor structures 26, 46 are illustrated according to an embodiment. The touch sensor structure 26 includes a GFF structure for a mutual capacitance touch sensor implementation. Thus, the touch sensor structure 26 incudes a cover-glass layer 28, a receive electrode layer 30, a film layer 32, a transmit electrode layer 34, and a film layer 36 on a display module 38. The display module 38 may include, for example, a color-filter glass of an LCD, an encapsulation glass of an OLED, and so on.

The cover-glass layer 28 may include a glass material such as quartz glass, non-alkali glass, crystallized transparent glass, soda-lime silica glass, chemically strengthened glass, heat strengthened glass, ion-exchange strengthened glass (e.g., potassium ion, alumino-silica, etc.), plastic glass (e.g., isobutyl methacrylate, etc.), sapphire glass, and so on. In addition, the film layer 32 and the film layer 36 may include a polymer material, which may be the same or different type of polymer. For example, the film layer 32 and the film layer 36 may include PET, COP, COCP, PI, PC, TAC, and so on.

The illustrated receive electrode layer 30 includes receive electrode patterns 40 formed on one side of the film layer 32 that faces the cover-glass layer 28. In addition, the illustrated transmit electrode layer 34 includes transmit electrode patterns 42 formed on the film layer 36 that faces the cover-glass layer 28. Each of the electrode patterns 40, 42 may be formed of a network of metal nanowires such as SNWs. Moreover, the electrode patterns 40, 42 are parallel and aligned with one another to form X,Y dimensions for the mutual capacitance touch sensor implementation.

Notably, the electrode patterns 40, 42 may be formed utilizing a fabrication rule based on a visibility level, which may be a function of and/or may specify an inter-pattern spacing, a pattern width, a periodicy, a pitch, and/or other factors such as such sheet resistance, optical transmittance, flexibility, haze, color index, electric field uniformity, and so on. In this regard, a majority of visibility level (e.g., from differences in reflectance) may be caused by the receive electrode layer 30 (e.g., a top electrode layer relative to a bottom electrode layer). Accordingly, the receive electrode layer 30 may be formed utilizing a fabrication rule that is a function of and/or that specifies an inter-pattern spacing between about 1 μm and about 60 μm, a pattern width between about 1 μm and 250 μm, and/or a periodicy including a period of at least one sensor pattern to provide a specific visibility level that is suitable for a touch screen sensor application. The transmit electrode layer 34 may be formed utilizing the same fabrication rule used to form the receive electrode layer 30 to further maximize visibility level advantages (e.g., minimize visibility level).

In addition, an adhesive 44 may be disposed between two or more layers of the touch sensor structure 26 to merge two or more adjacent layers with one another. The adhesive 44 may include a same adhesive or a different adhesive throughout the touch sensor structure 26. The adhesive 44 may include pressure sensitive adhesive, a structural adhesive, and so on. In general, structural adhesives may harden via evaporation of solvent, reaction with UV radiation, chemical reaction, cooling, and so on. Pressure-sensitive adhesives (PSAs) may form a bond by an application of pressure to merge the adhesive with an adherend. The adhesive 44 may also include an optically clear adhesive (OCA), a liquid OCA (LOCA), and so on. Thus, the adhesive 44 that merges the cover-glass layer 28 with the receive electrode layer 30 may include an acrylic PSA while the adhesive 44 that merges the transmit electrode layer 34 with the film layer 32 may include an epoxy PSA.

As illustrated in FIG. 2B, the touch sensor structure 46 includes a GF2 structure for a mutual capacitance touch sensor implementation. The illustrated touch sensor structure 46 incudes the cover-glass layer 28, the receive electrode layer 30, the film layer 32, and the transmit electrode layer 34 on the display module 38. The illustrated receive electrode layer 30 includes the receive electrode patterns 40 formed on a side of the film layer 32 that faces the cover-glass layer 28. The illustrated transmit electrode layer 34 includes the transmit electrode patterns 42 formed on an opposite side of the film layer 32 that faces the display module 38. Moreover, the illustrated electrode patterns 40, 42 are parallel and alternating with one another to form X,Y dimensions for the mutual capacitance touch sensor implementation. Notably, the electrode patterns 40, 42 may be in any desired position relative to each other, such as parallel (e.g., one-layer solution), orthogonal (e.g., two layers such as GFF and GF2), overlapping with variable angles, and so on.

FIGS. 3A and 3B illustrate an example of a computing device 48 including a touch sensor component according to an embodiment. The computing device 48 may include, for example, a mobile hand-held computing platform such as a smart phone, a tablet, and so on. The illustrated computing device 48 includes a touch screen 50 having a dark portion 52, which does not display content to an individual, and an open portion 54, which does display content to the individual. The touch sensor component may be included in a sensor structure (e.g., GFF, GF2, etc.) for a mutual capacitance touch sensor implementation. The illustrated touch sensor component includes transmit electrode patterns 58 and receive electrode patterns 64, which may be orthogonal to one another to form X,Y dimensions for the mutual capacitance touch sensor implementation.

As illustrated in FIG. 3A, the transmit electrode patterns 58 form a plurality of rows or columns as one of the X,Y dimensions for the mutual capacitance touch sensor implementation. All of the transmit electrode patterns 58 form a set of patterns across substantially the entire area of the open portion 54. The transmit electrode patterns 58 may include an inter-pattern spacing between about 1 μm and about 60 μm and a pattern width between about 1 μm and about 250 μm.

In the illustrated example, the inter-pattern spacing and the pattern width of the transmit electrode patterns 58 are the same size (e.g., repeat by a period of 1 sensor pattern). In addition, at least a portion of the set of patterns is segmented into subsets 60 (60a, 60b, 60c, 60d, 60e) of patterns that are coupled to reduce the resistance for channels 62 (62a, 62b, 62c, 62d, 62e). For example, the resistance for the channels 62 may be relatively lower compared to the resistance for the members of the portion of the set of patterns taken individually. Thus, for example, the resistance for the channel 62a may be relatively lower than the resistance for the patterns taken individually that form the subset 60a.

As illustrated in FIG. 3A, the subsets 60 may form a periodical repeat of sensor patterns (e.g., a repeat of subsets of patterns). In addition, dummy patterns 63 are interspersed with the subsets 60. Also, the dummy patterns 63 are formed utilizing the same fabrication rule (e.g., specified inter-pattern spacing, specified pattern width, etc.) as used to form the transmit electrode patterns 58 to provide desired electrical properties with maximized visibility advantages (e.g., minimized visibility level). Relatively small changes in shape of the dummy patterns 63 may be utilized under consideration of yield and/or electrical capacitance matching (e.g., with touch IC). For example, one or more open areas (e.g., intra-pattern spacing) may be provided having a relatively small size, wherein the size or the location of the open areas may be the same or different within the dummy patterns 63. Thus, the fabrication rule may specify implementing a relatively small number of open areas including a relatively small size (e.g., intra-pattern spacing).

Moreover, the transmit electrode patterns 58 in each of the subsets 60 are coupled to one another in the dark portion 52 to minimize malfunction in an edge of the open portion 54 when a conductive object approaches the touch screen 50. The channels 62 (e.g., bus bar) may connect the transmit electrode patterns 58 with other hardware components of the computing device 48, such as a voltage driver. Notably, the transmit electrode patterns 58 are not observable under visual inspection (e.g., to the naked eye), including the parts located in the dark portion 52.

As illustrated in FIG. 3B, the receive electrode patterns 64 form a plurality of rows or columns as one of the X,Y dimensions for the mutual capacitance touch sensor implementation. All of the receive electrode patterns 64 form a set of patterns across substantially the entire area of the open portion 54. The receive electrode patterns 64 may include an inter-pattern spacing between about 1 μm and about 60 μm and a pattern width between about 1 μm and about 250 μm. The inter-pattern spacing, the pattern width, and/or the periodicy may be the same or different for the receive electrode patterns 64 relative to the transmit electrode patterns 58.

In the illustrated example, the inter-pattern spacing and the pattern width of the receive electrode patterns 64 are the same size (e.g., repeat by a period of 1 sensor pattern). In addition, at least a portion of the set of patterns are segmented into subsets 66 (66a, 66b, 66c, 66d) of patterns that are coupled to reduce the resistance for channels 68 (68a, 68b, 68c, 68d). For example, the resistance for the channels 68 may be relatively lower compared to the resistance for the members of the portion of the set of patterns taken individually. Thus, the resistance for the channel 68a may be relatively lower than the resistance for the patterns taken individually that form the subset 66a.

As illustrated in FIG. 3B, the subsets 66 may form a periodical repeat of sensor patterns (e.g., a repeat of subsets of patterns). In addition, dummy patterns may be interspersed with the subsets 66 to provide desired electrical properties with maximized visibility advantages (e.g., minimized visibility level). In one example, the dummy patterns may be formed utilizing the same fabrication rule (e.g., specified inter-pattern spacing, specified pattern width, etc.) as used to form the receive electrode patterns 64. Relatively small changes in shape of the dummy patterns may be utilized under consideration of yield and/or electrical capacitance matching (e.g., with touch IC). For example, one or more open areas (e.g., intra-pattern spacing) may be provided having a relatively small size, wherein the size or the location of the open areas may be the same or different within the dummy patterns. Thus, the fabrication rule may specify implementing a relatively small number of open areas including a relatively small size (e.g., intra-pattern spacing).

Moreover, the receive electrode patterns 64 in each of the subsets 66 are coupled to one another in the dark portion 52 to minimize malfunction in an edge of the open portion 54 when a conductive object approaches the touch screen 50. The channels 68 (e.g., bus bar) may be connected to other hardware components of the computing device 48, such as an A/D converter, a processor, and so on. Notably, the receive electrode patterns 64 are not observable under visual inspection (e.g., to the naked eye), including the parts located in the dark portion 52.

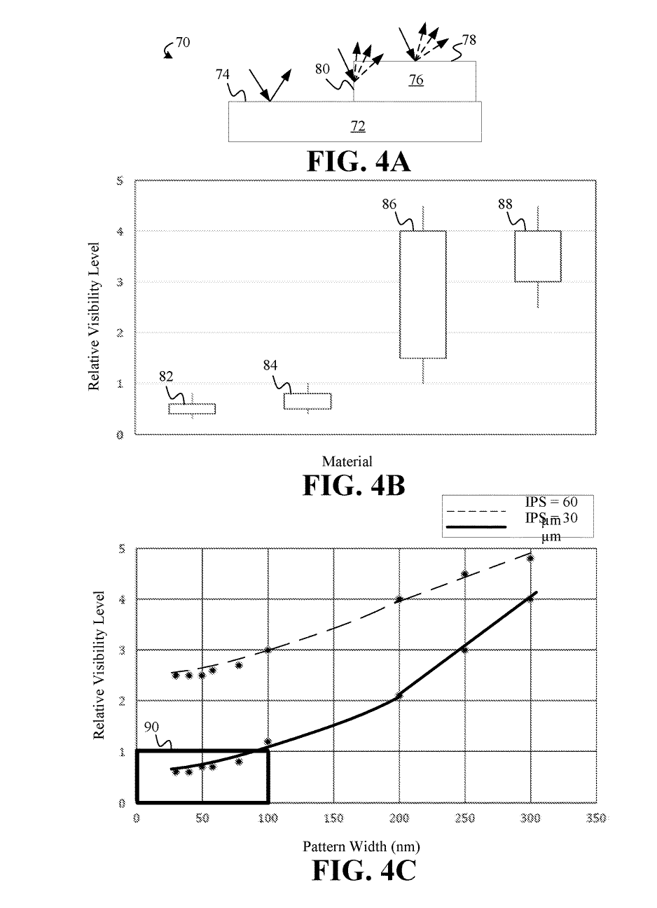

Turning now to FIGS. 4A to 4C, an example of an approach to determine a fabrication rule based at least on a visibility level is illustrated according to an embodiment. In the illustrated example, a touch sensor component 70 includes a substrate 72 and a sensor pattern 76. As illustrated in FIG. 4A, a relatively high visibility level may be caused by a difference in reflectance of light from a surface 74 of the substrate 72 and in reflectance of light from a surface 78 of the sensor pattern 76. In addition, a relatively high visibility level may be caused by scattering of light from an edge 80 of the sensor pattern 76. A process implemented to form the sensor pattern 76 may relatively reduce the scattering of light from the edge 80. For example, ink-jet printing may be implemented to relatively reduce the scattering of light from the edge 80 by rounding the edge 80.

A visibility level of the sensor pattern 76 may be relatively quantified as an amount in which the sensor pattern 76 is observable by visual inspection (e.g., when an individual looks at the pattern) under ambient lighting conditions (e.g., room luminescence of about 1000 lux to about 1500 lux) against a background without the use of specialized optical aids (e.g., a low-power magnifier, a microscope, a fiber-optic device, etc.). The background may maximize contrast, and may include a solid black background, a solid white background, and so on. The visibility level of the sensor pattern 76 may be objectively and accurately quantified using a relative visibility scale having a minimum visibility level and a maximum visibility level, a reference visibility level corresponding to a reference material, and/or a pre-determined threshold visibility level corresponding to a specific sensor application.

The visibility level for the sensor pattern 76 may be determined by placing a black object against a black background to set a visibility level to zero, a white object against the black background to set a visibility level to five, and measuring the visibility level of the sensor pattern 76 relative to the minimum visibility level and the maximum visibility level by visual inspection against the black background under ambient conditions without the use of specialized optical aids. Visual inspection of the sensor component 70 and/or the sensor pattern 76 may provide an accurate suitability determination for use in a touch screen sensor application since the sensor pattern 76 may be encountered under similar conditions (e.g., a black or white background when a device is in sleep mode, powered off, presenting content having bright or dark areas, etc.). Thus, there may be a confirmation for suitability of the sensor pattern 76 in a touch sensor application.

As illustrated in FIGS. 4B and 4C, a visibility scale may be partitioned into equal segments between the minimum visibility level (e.g., zero) and the maximum visibility level (e.g., five). The visibility level for the sensor pattern 76 may be determined against the visibility levels for the segments (e.g., 0-5), wherein the sensor pattern 76 may be deemed as suitable for touch screen sensor applications when the visibility level is between, e.g., 0 and 1. The visibility level for the sensor pattern 76 may also be determined against the visibility levels for the segments in combination with a reference visibility level for a reference material. For example, ITO film 82 and ITO OGS 84 may have a visibility level between about 0 and about 1 in the illustrated visibility scale, MM 86 may have a visibility above about 1 to about 4.5 in the illustrated visibility scale, and SNW 88 (not formed using a fabrication rule) may have a visibility level above about 2.5 to 4.5 in the illustrated visibility scale. Thus, the visibility level for the sensor pattern 76 may be determined against the visibility levels for the segments (e.g., between 0 and 5) in combination with the reference visibility levels such as, e.g., between 0 and 1 for ITO materials.

Moreover, a pre-determined threshold visibility level may be set to further indicate the suitability of the sensor pattern 76 for use in a particular sensor application. For example, the threshold visibility level may be set equal to or less than 3 in the illustrated visibility scale. Generally, patterns that are conventionally used in touch screen sensor applications have a visibility level equal to or less than 3 in the illustrated visibility scale. In this regard, the ITO film 82 and the ITO OGS 84 conventionally used in touch screen sensor applications have a visibility level between about 0 and about 1 in the illustrated visibility scale, MM 86 used in touch screen sensor applications has a visibility level above about 1 to about 3 in the illustrated visibility scale, and SNW 88 (not formed using a fabrication rule) used in touch screen sensor applications has a visibility level above about 2.5 to about 3 in the illustrated visibility scale.

In one embodiment, a fabrication rule based on a visibility level may be utilized to form the sensor pattern 76. For example, inter-pattern spacing and pattern width of the sensor pattern 76 may be determined and/or may be specified for a visibility level that is suitable for touch screen sensor applications. In one example, a fabrication rule may specify an inter-pattern spacing of about 30 μm (or less) and a pattern width of about 100 μm (or less) for the sensor pattern 76 to provide a visibility level that is similar to the ITO film 82 and the ITO OGC 84 in an area 90 (e.g., visibility level of about 1). Other advantages may include relatively good sheet resistivity and optical transmittance, relatively less fabrication or material cost, relatively better flexibility, relatively easy fabrication processes (e.g., ink-jet), etc.

The visibility level may increase to a visibility level (e.g., about 3) that may be tolerated for some touch screen sensor applications when the inter-pattern spacing is maintained at about 30 μm and the pattern width increases to about 250 nm. The visibility level may also increase to about 3 when the inter-pattern spacing changes from about 30 μm to about 60 μm, although the pattern width is maintained at about 100 nm. Above the pre-determined threshold of 3, the visibility level for the sensor pattern 76 may become intolerable for touch screen sensor applications.

Accordingly, a pitch of about 160 μm (e.g., an inter-pattern spacing of about 60 μm and a pattern width of about 100 μm) may provide a visibility level of about 3, an optical transmittance of about 92.3%, haze of about 0.71%, and a color index of about 0.93. The visibility level may become intolerable (e.g., above 3), however, when the pitch changes from about 160 μm to about 180 μm (e.g., inter-pattern spacing is maintained at about 60 μm while the pattern width changes from about 100 μm to about 120 μm), although optical transmittance may be about 92.5%, haze may be about 0.68%, and color index may be about 0.89. Thus, the fabrication rule may be determined based on a visibility level, and may be a function of and/or may specify an inter-pattern spacing and pattern width to provide a specific visibility level.

The fabrication rule may further be a function of and/or may specify pattern periodicy. For example, the pattern periodicy may define a combination of visibility variables, such as specified inter-pattern space, pattern width, etc., to provide a periodical repeat of sensor patterns. In one example, the fabrication rule may specify a periodicy including a period of at least one sensor pattern, of at least two patterns, etc. The fabrication rule may further be a function and/or specify an average of pitch (and/or variables thereof). As illustrated in FIG. 4C, a pitch of about 160 μm (e.g., about 60 μm inter-pattern spacing and about 100 μm pattern width) having a visibility level of about 3 may be averaged with a pitch of about 130 μm (e.g., about 30 μm inter-pattern spacing and about 100 μm pattern width) having a visibility level of about 1 to provide an average pitch of about 145 μm (e.g., about 90 μm inter-pattern space and about 100 μm pattern width) with an average visibility level of about 2, which may be utilized to form a touch screen sensor.

The fabrication rule may also be a function of and/or may specify other factors such as such as sheet resistance, optical transmittance, flexibility, haze, color index, electric field uniformity, and so on. For example, a gradual and/or minimized change in electric field may dictate that changes in inter-patterns spacing, patterns width, periodicy, pitch, etc., be omitted, minimized and/or gradually implemented.

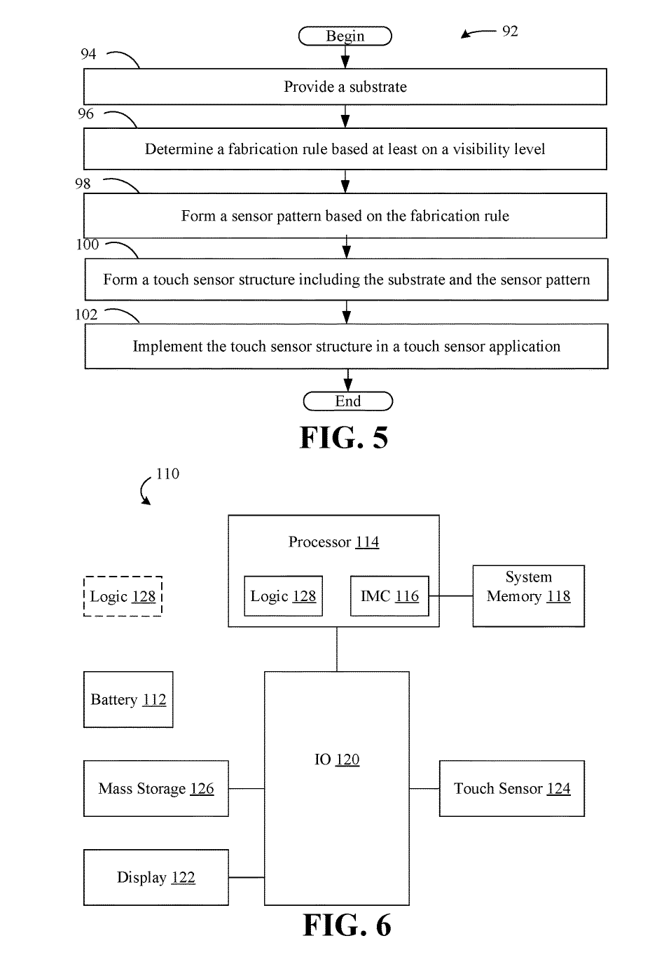

FIG. 5 illustrates an example of a method 92 to form and/or implement a touch sensor component including a substrate and a sensor pattern according to an embodiment. The method 92 may be implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 92 may be written in any combination of one or more programming languages, including an object oriented programming language such as C++ or the like and conventional procedural programming languages, such as the “C” programming language or similar programming languages. Moreover, the method 92 may be implemented using any of the herein mentioned circuit technologies.

Illustrated processing block 94 includes providing the substrate. The substrate may include, for example, a glass material such as quartz glass, non-alkali glass, crystallized transparent glass, soda-lime silica glass, chemically strengthened glass, heat strengthened glass, ion-exchange strengthened glass (e.g., potassium ion, alumino-silica, etc.), plastic glass (e.g., isobutyl methacrylate, etc.), sapphire glass, and so on. The substrate may also include a polymer material such as PET, COP, COCP, PI, PC, TAC, and so on.

Illustrated processing block 96 includes determining a fabrication rule based at least on a visibility level for a touch screen sensor application, wherein the fabrication rule may specify an inter-pattern spacing and a pattern width to provide the visibility level. For example, the processing block 96 may determine a visibility level of ITO film, ITO OGS, MM, and/or conventional SNW materials for a touch screen sensor application. In addition, the processing block 96 may determine and/or may specify an inter-pattern spacing between about 1 μm and about 60 μm, and a pattern width between about 1 μm and 250 μm, to provide a visibility level that is suitable for touch screen sensor applications. Thus, for example, the processing block 96 may provide a fabrication rule that specifies an inter-pattern spacing between about 1 μm and about 30 μm (or less), and a pattern width between about 1 μm and 100 μm (or less), to provide a substantially similar visibility level as ITO films and ITO OGS for a touch screen sensor application.

The processing block 96 may further determine and/or may specify pattern periodicy. For example, the pattern periodicy may define a combination of visibility variables, such as specified inter-pattern space, pattern width, and/or pitch, to provide a periodical repeat of sensor patterns. In one example, the fabrication rule may specify a periodicy including a period of at least one sensor pattern, a period of at least two sensor patterns, and so on.

The processing block 96 may further specify an average of pitch (and/or variables thereof). For example, the processing block 96 may specify a pitch for a first sensor pattern and a pitch for a second sensor pattern, wherein the sensor pattern may be formed based on an average visibility level determined from the pitch for the first sensor pattern and the pitch for the second sensor pattern. It this regard, visibility variables (e.g., inter-pattern spacing, pattern width) of a first pitch and of a second pitch may be individually averaged and individually evaluated to confirm that the average inter-pattern spacing and the average pattern width fall within boundaries of a pre-determined range (e.g., intern-pattern spacing less than or equal to 30 μm, pattern width less than or equal 100 μm for ITO-level visibility). The processing block 96 may also specify a coupling location, subset configuration, and so on. Notably, the sensor pattern may not be observable under visual inspection to the naked eye (e.g., without specialized equipment).

The processing block 96 may further determine and/or may specify other factors to determine the fabrication rule such as sheet resistance, optical transmittance, flexibility, haze, color index, electric field uniformity, and so on. For example, the fabrication rule may determine and/or may specify that any changes in inter-pattern spacing, pattern width, periodicy, pitch, resistance, etc., be omitted, minimized, and/or gradually implemented.

Illustrated processing block 98 provides for forming a sensor pattern on the substrate based on the fabrication rule. The sensor pattern may be formed of metal nanowires, such as SNW networks. Accordingly, the processing block 98 may implement heat and pressure processes, coating processes, deposition processes (e.g., chemical vapor deposition (CVD), physical vapor deposition (PVD), electrodeposition, etc.), laser patterning processes, lithography patterning processes, screen printing processes, inkjet printing processes, and so on. For example, SNWs may be diluted with water and sonicated in a sonic bath. Vacuum filtration may then be accomplished using porous mixed cellulose ester filter membranes, followed by transfer to a PET substrate using heat and pressure. The heat and pressure process may generate sensor patterns on a substrate having sheet resistance of about 13 Ω/sq to about 30 Ω/sq and an optical transmittance (e.g., transparency) of about 85%.

In another example, a roll-to-roll method including slot-die coating on plastic films may be utilized to fabricate the sensor pattern, wherein an aqueous dispersion of SNW is coated and dried on a substrate. An adhesive, such as an optically clear adhesive (OCA) or a liquid OCA (LOCA), may be utilized when the sensor pattern is to be merged with another layer of a sensor structure (e.g., cover-glass). The roll-to-roll method may generate sensor patterns on a substrate having sheet resistance of about 10 Ω/sq to about 250 Ω/sq and an optical transmittance (e.g., transparency) of about 90% to about 98%.

Patterning may be accomplished by dry-etching techniques such as, for example, laser patterning including diode-pumped and/or fiber-based laser systems with 1064 nm infrared wavelength, 532 nm visible wavelength, 355 nm ultra-violet wavelength, and so on. For example, infrared laser patterning may provide an inter-pattern space of about 35 μm. Patterning may also be accomplished using photolithography and wet-etching techniques. Generally, patterns may be made by exposure of a layer of photosensitive lacquer (e.g., photoresist) though a mask. Light exposure (e.g., UV) may induce a chemical change in light sensitive material, which changes its solubility in a developer solution. Exposed areas may be removed for positive resists and unexposed areas may be removed for negative resists. Photolithography and wet-etching may provide an inter-pattern space of about 30 μm or less (e.g., about 1 μm).

Direct printing techniques, such as screen printing and ink-jet printing, may be used to eliminate various processing steps and materials utilized in dry etching or wet-etching techniques. Moreover, direct printing techniques may provide relatively high resolution for both inter-pattern spacing and pattern width. In screen printing, a silver nanowire dispersion may be pressed with a squeegee through a screen onto a substrate. The squeegee may be formed from rubber and the screen may be formed from a porous mesh of fabric or stainless steel material, wherein the screen may be stretched tightly over a frame formed from wood or metal. A stencil (e.g., an image to be replicated) may be photochemically or manually defined on the mesh to form a wide variety of sensor patterns on a wide variety of substrates. Electrical contacts formed from, e.g., epoxy silver paste and conjugated polymer may also be screen printed.

In direct ink-jet printing, a dispersion of SNWs may be deposited on the substrate (e.g., glass, PET, etc.) using conventional inkjet printers to form the sensor patterns on the substrate. An electrohydrodynamic (EHD) jet printer, which uses electric fields rather than thermal or acoustic energy, may also be used to form the sensor patterns on the substrate. Generally, a dispenser array configuration (e.g., nozzle spacing, orifice size, etc.) and/or a droplet size may be tailored to provide a desired deposition output. Moreover, a dimension (e.g., thickness) of the sensor patterns may be controlled by specifying an ejection speed from the dispenser array configuration, by specifying a speed and/or a number of deposition passes, by specifying a concentration of a dispersion of SNWs, and so on. For example, a final concentration of a dispersion of SNWs used for fabricating the sensor patterns 14 may be controlled via n-fold (e.g., two-fold, three-fold, etc.) dilutions of stock concentrations. Ink-jet printing may form a sensor pattern that includes, for example, an inter-pattern spacing between about 10 μm and about 60 μm (e.g., about 30 μm), and a pattern width between about 1 μm and 250 μm (e.g., about 100 μm), relatively easily, relatively quickly, and at relatively low cost.

In addition, ink-jet printing may further include applying disperse wet etchant through an ink-jet nozzle. For example, SWNs may be provided (e.g., coated, etc.) on a substrate, and disperse wet etchant may selectively etch portions of the SWNs to provide a sensor pattern. In one example, an ink-jet printer may spray wet etchant for an inter-pattern spacing, such that (e.g., after a cleaning operation) the inter-pattern spaces are formed and the sensor patterns remain.

Illustrated processing block 100 provides for forming a touch sensor structure including the substrate and the sensor pattern. For example, the processing block 100 may form a glass-only structure, a film-only structure, a glass-and-film structure, an on-cell structure, and so on. In this regard, the processing block 100 may determine and/or may specify an adhesive, one or more sensor structure layers, a display module, and so on.

Illustrated processing block 102 includes implementing the touch sensor structure in a touch screen sensor application. For example, the touch sensor structure may be implemented in a capacitance touch sensor implementation, such as a surface capacitance touch sensor implementation, a self-capacitance touch sensor implementation, a mutual capacitance touch sensor implementation, and so on. In this regard, the processing block 102 may determine and/or may specify platform hardware, a connection (e.g., a channel) between the sensor pattern and the platform hardware, and so on.

Generally, in a surface capacitance touch sensor implementation, a voltage may be applied to sensor patterns formed on one side of the substrate, resulting in a uniform electric field, and a capacitor may be formed when a conductive object hovers over or touches an opposite side of the substrate. The location of the interaction (e.g., touch) may be determined indirectly from a change in capacitance as measured by four corners of a touch screen assembly.

In a projected capacitance touch sensor implementation, sensor patterns may be disposed in X,Y dimensions to detect changes in capacitance. In one example, the sensor patterns may be disposed in X,Y dimensions (e.g., a grid of rows and columns) to operate independently in a self-capacitance touch sensor implementation, wherein capacitive load of a conductive object may be individually measured on the X,Y dimensions at each of the sensor patterns (e.g., on each column electrode or each row electrode of a grid). In another example, the sensor patterns may be disposed in X,Y dimensions (e.g., a grid of rows and columns) to form a capacitor between the sensor patterns (e.g., at each intersection of a grid) in a mutual capacitance touch sensor implementation. An applied voltage provided to one of the X,Y dimensions (e.g., a row or a column of a grid) forms a uniform electric field, wherein a change in the local electric field that is caused by a conductive object reduces mutual capacitance, and wherein the capacitance change may be measured using the other of X,Y dimensions without the applied voltage.

The X,Y dimensions may be provided by forming the sensor patterns on a same side of the substrate. In one example, the sensor patterns may be disposed in a same layer of a touch sensor structure (e.g., a transmit and receive electrode layer). In this regard, the sensor patterns may form a one-layer solution having an interdigitated structure of two or more patterns, a tapered structure of two or more patterns, a parallel structure of two or more patterns, and so on.

In another example, the X,Y dimensions may be provided by forming the sensor patterns on different sides of the substrate. For example, sensor patterns may be disposed on opposite sides of the substrate (e.g., a transmit electrode layer and a receive electrode layer). In this regard, two or more patterns that are orthogonal to each other may form X,Y dimensions, two or more patterns that are parallel and aligned to each other may form X,Y dimensions, two or more patterns that are parallel and alternating to each other may form X,Y dimensions, two or more patterns that overlap one another at various angles may for X,Y dimensions, and so on.

Notably, the method 92 may be accomplished in parallel, sequentially, and in any order. Moreover, the method 92 may include one or more of the herein mentioned processes. For example, the method 92 may include confirming a suitability of the sensor pattern for a touch sensor application.

Turning now to FIG. 6, a computing device 110 is illustrated according to an embodiment. The computing device 110 may be part of a platform having computing functionality (e.g., personal digital assistant/PDA, notebook computer, tablet computer), communications functionality (e.g., wireless smart phone), imaging functionality, media playing functionality (e.g., smart television/TV), wearable functionality (e.g., watch, eyewear, headwear, footwear, jewelry) or any combination thereof (e.g., mobile Internet device/MID). In the illustrated example, the device 110 includes a battery 112 to supply power to the device 110 and a processor 114 having an integrated memory controller (IMC) 116, which may communicate with system memory 118. The system memory 118 may include, for example, dynamic random access memory (DRAM) configured as one or more memory modules such as, for example, dual inline memory modules (DIMMs), small outline DIMMs (SODIMMs), etc.

The illustrated device 110 also includes a input output (10) module 120, sometimes referred to as a Southbridge of a chipset, that functions as a host device and may communicate with, for example, a display 122 (e.g., touch screen, liquid crystal display/LCD, light emitting diode/LED display), a touch sensor 124 (e.g., touch sensor component, touch sensor structure, etc.), and mass storage 126 (e.g., hard disk drive/HDD, optical disk, flash memory, etc.). The illustrated processor 114 may execute logic 128 (e.g., logic instructions, configurable logic, fixed-functionality logic hardware, etc., or any combination thereof) configured to implement any of the herein mentioned processes and/or touch sensor technologies, including one or more of the processing blocks 94-102 (FIG. 5).

For example, the logic 128 may include substrate logic to provide, determine, and/or specify a substrate. In addition, the logic 128 may include fabrication rule logic to provide, determine, and/or specify a fabrication rule (and/or variables/factors thereof), which may be based at least on a visibility level. Moreover, the logic 128 may include formation logic to form one or more sensor patterns on the substrate based on the fabrication rule. The logic 128 may also include touch sensor structure logic to provide, determine, and/or specify a touch sensor structure. The logic 128 may also include implementation logic to provide, determine, and/or specify the touch sensor structure in a touch sensor application, such as a touch screen sensor application, a capacitance touch sensor application, etc.

One or more aspects of the logic 128 may alternatively be implemented external to the processor 114. Additionally, the processor 114 and the IO module 120 may be implemented together on the same semiconductor die as a system on chip (SoC).

### ADDITIONAL NOTES AND EXAMPLES

Example 1 may include a touch sensor component comprising a substrate, and two or more sensor patterns formed on the substrate based on a visibility level for a touch screen sensor application, wherein the two or more sensor patterns each include a specified inter-pattern spacing and a specified pattern width to provide the visibility level, and wherein the two or more sensor patterns are each to include silver nanowire networks and are not to be observable by visual inspection.

Example 2 may include the touch sensor component of Example 1, wherein the substrate includes one or more of a glass material and a polymer material.

Example 3 may include the touch sensor component of any one of Examples 1 to 2, wherein the substrate and the two or more patterns are to be included in a touch sensor structure for a capacitance touch sensor.

Example 4 may include the touch sensor component of any one of Examples 1 to 3, wherein the touch sensor structure is to include a portion of the two or more patterns being coupled in a dark area of a touch screen to form a subset of patterns, wherein the subset of patterns are to include a reduced resistance relative to a resistance of the portion of the two or more patterns taken individually.

Example 5 may include the touch sensor component of any one of Examples 1 to 4, further including a specified pattern periodicy including a period of at least one sensor pattern, wherein the two or more sensor patterns are to include a same specified size of the specified inter-pattern spacing and a same specified size of the specified pattern width when the specified periodicy is to include a period of one sensor pattern to provide a periodical repeat of sensor patterns.

Example 6 may include the touch sensor component of any one of Examples 1 to 5, wherein the visibility level is to include a specified average visibility level determined from a specified pitch for a first sensor pattern and a specified pitch for a second sensor pattern.

Example 7 may include the touch sensor component of any one of Examples 1 to 6, further including a specified average pitch based on an average of variables of the specified pitch for the first sensor pattern with corresponding variables of the specified pitch for the second sensor pattern, wherein the average visibility level is to be determined based on the average pitch.

Example 8 may include the touch sensor component of any one of Examples 1 to 7, further including a dummy pattern interspersed between two sensor patterns of the two or more sensor patterns.

Example 9 may include the touch sensor component of any one of Examples 1 to 8, wherein the specified inter-pattern spacing is to be between about 1 μm and about 60 μm and the specified pattern width is to be between about 1 μm and about 250 μm to provide the visibility level.

Example 10 may include the touch sensor component of any one of Examples 1 to 9, wherein the specified inter-pattern spacing is to be between about 1 μm and about 30 μm and the specified pattern width is to be between about 1 μm and about 100 μm to provide the visibility level that is to be substantially the same as a visibility level of an indium tin oxide touch screen sensor material.

Example 11 may include a method to form and/or to implement a touch sensor component comprising providing a substrate, determining a fabrication rule based at least on a visibility level for a touch screen sensor application, wherein the fabrication rule specifies an inter-pattern spacing and a pattern width to provide the visibility level, and forming two or more sensor patterns on the substrate based on the fabrication rule, wherein the two or more sensor patterns each include silver nanowire networks and are not observable by visual inspection.

Example 12 may include the method of Example 11, wherein the substrate includes one or more of a glass material and a polymer material.

Example 13 may include the method of any one of Examples 11 to 12, wherein forming the two or more sensor patterns includes one or more of a screen printing process and an ink-jet process.

Example 14 may include the method of any one of Examples 11 to 13, further including forming a touch sensor structure including the substrate and the two or more sensor patterns, and utilizing the touch sensor structure in a capacitance touch sensor implementation.

Example 15 may include the method of any one of Examples 11 to 14, further including coupling a portion of the two or more patterns in a dark area of a touch screen to form a subset of patterns, wherein the subset of patterns includes a reduced resistance relative to a resistance of the portion of the two or more patterns taken individually.

Example 16 may include the method of any one of Examples 11 to 15, wherein the fabrication rule is to further specify a periodicy including a period of at least one sensor pattern, wherein the two or more sensor patterns include a same size of the inter-pattern spacing and a same size of the pattern width when the specified periodicy includes a period of one sensor pattern to provide a periodical repeat of sensor patterns.

Example 17 may include the method of any one of Examples 11 to 16, further including specifying a pitch for a first sensor pattern and a pitch for a second pattern, and determining an average visibility level from the pitch for the first sensor pattern and the pitch for the second sensor pattern.

Example 18 may include the method of any one of Examples 11 to 17, further including averaging variables of the pitch for the first sensor pattern with corresponding variables of the pitch for the second sensor pattern to determine an average pitch, and determining the average visibility level based on the average pitch.

Example 19 may include the method of any one of Examples 11 to 18, further including forming a dummy pattern interspersed between two sensor patterns of the two or more sensor patterns.

Example 20 may include the method of any one of Examples 11 to 19, wherein the fabrication rule specifies that the inter-pattern spacing is between about 1 μm and about 60 μm and the pattern width is between about 1 μm and about 250 μm to provide the visibility level for the touch screen sensor application.

Example 21 may include the method of any one of Examples 11 to 20, wherein the fabrication rule specifies that the inter-pattern spacing is between about 1 μm and about 30 μm and the pattern width is between about 1 μm and about 100 μm to provide the visibility level that is substantially the same as a visibility level of an indium tin oxide touch screen sensor material.

Example 22 may include at least one computer readable storage medium comprising one or more instructions that when executed on a computing device cause the computing device to provide a substrate, determine a fabrication rule based at least on a visibility level for a touch screen sensor application, wherein the fabrication rule is to specify an inter-pattern spacing and a pattern width to provide the visibility level, and form two or more sensor patterns on the substrate based on the fabrication rule, wherein the two or more sensor patterns are each to include silver nanowire networks and are not to be observable by visual inspection.

Example 23 may include the at least one computer readable storage medium of Example 22, wherein the substrate is to include one or more of a glass material and a polymer material.

Example 24 may include the at least one computer readable storage medium of any one of Examples 22 to 23, wherein when executed the one or more instructions cause the computing device to form the two or more sensor patterns by one or more of a screen printing process and an ink-jet process.

Example 25 may include the at least one computer readable storage medium of any one of Examples 22 to 24, wherein when executed the one or more instructions cause the computing device to form a touch sensor structure that is to include the substrate and the two or more sensor patterns, and utilize the touch sensor structure in a capacitance touch sensor implementation.

Example 26 may include the at least one computer readable storage medium of any one of Examples 22 to 25, wherein when executed the one or more instructions cause the computing device to couple a portion of the two or more patterns in a dark area of a touch screen to form a subset of patterns, wherein the subset of patterns is to include a reduced resistance relative to a resistance of the portion of the two or more patterns taken individually.

Example 27 may include the at least one computer readable storage medium of any one of Examples 22 to 26, wherein the fabrication rule is to further specify a periodicy including a period of at least one sensor pattern, wherein the two or more sensor patterns are to include a same size of the inter-pattern spacing and a same size of the pattern width when the specified periodicy is to include a period of one sensor pattern to provide a periodical repeat of sensor patterns.

Example 28 may include the at least one computer readable storage medium of any one of Examples 22 to 27, wherein when executed the one or more instructions cause the computing device to specify a pitch for a first sensor pattern and a pitch for a second pattern, and determine an average visibility level from the pitch for the first sensor pattern and the pitch for the second sensor pattern.

Example 29 may include the at least one computer readable storage medium of any one of Examples 22 to 28, wherein when executed the one or more instructions cause the computing device to average variables of the pitch for the first sensor pattern with corresponding variables of the pitch for the second sensor pattern to determine an average pitch, and determine the average visibility level based on the average pitch.

Example 30 may include the at least one computer readable storage medium of any one of Examples 22 to 29, wherein when executed the one or more instructions cause the computing device to form a dummy pattern interspersed between two sensor patterns of the two or more sensor patterns.

Example 31 may include the at least one computer readable storage medium of any one of Examples 22 to 30, wherein the fabrication rule is to specify that the inter-pattern spacing is to be between about 1 μm and about 60 μm and the pattern width is to be between about 1 μm and about 250 μm to provide the visibility level for the touch screen sensor application.

Example 32 may include the at least one computer readable storage medium of any one of Examples 22 to 31, wherein the fabrication rule is to specify that the inter-pattern spacing is to be between about 1 μm and about 30 μm and the pattern width is to be between about 1 μm and about 100 μm to provide the visibility level that is to be substantially the same as a visibility level of an indium tin oxide touch screen sensor material.

Example 33 may include an apparatus to form and/or to implement a touch sensor component comprising means for providing a substrate, means for determining a fabrication rule based at least on a visibility level for a touch screen sensor application, wherein the fabrication rule specifies an inter-pattern spacing and a pattern width to provide the visibility level, and means for forming two or more sensor patterns on the substrate based on the fabrication rule, wherein the two or more sensor patterns each include silver nanowire networks and are not observable by visual inspection.

Example 34 may include the apparatus of Example 33, wherein the substrate includes one or more of a glass material and a polymer material.

Example 35 may include the apparatus of any one of Examples 33 to 34, wherein the means for forming the two or more sensor patterns includes one or more of a screen printing means and an ink-jet means.

Example 36 may include the apparatus of any one of Examples 33 to 35, further including means for forming a touch sensor structure including the substrate and the two or more sensor patterns, and means for utilizing the touch sensor structure in a capacitance touch sensor implementation.

Example 37 may include the apparatus of any one of Examples 33 to 36, further including means for coupling a portion of the two or more patterns in a dark area of a touch screen to form a subset of patterns, wherein the subset of patterns include a reduced resistance relative to a resistance of the portion of the two or more patterns taken individually.

Example 38 may include the apparatus of any one of Examples 33 to 37, wherein the fabrication rule is to further specify a periodicy including a period of at least one sensor pattern, wherein the two or more sensor patterns include a same size of the inter-pattern spacing and a same size of the pattern width when the specified periodicy includes a period of one sensor pattern to provide a periodical repeat of sensor patterns.

Example 39 may include the apparatus of any one of Examples 33 to 38, further including means for specifying a pitch for a first sensor pattern and a pitch for a second pattern, and means for determining an average visibility level from the pitch for the first sensor pattern and the pitch for the second sensor pattern.

Example 40 may include the apparatus of any one of Examples 33 to 39, further including means for averaging variables of the pitch for the first sensor pattern with corresponding variables of the pitch for the second sensor pattern to determine an average pitch, and means for determining the average visibility level based on the average pitch.

Example 41 may include the apparatus of any one of Examples 33 to 40, further including means for forming a dummy pattern interspersed between two sensor patterns of the two or more sensor patterns.

Example 42 may include the apparatus of any one of Examples 33 to 41, wherein the fabrication rule specifies that the inter-pattern spacing is between about 1 μm and about 60 μm and the pattern width is between about 1 μm and about 250 μm to provide the visibility level for the touch screen sensor application.

Example 43 may include the apparatus of any one of Examples 33 to 42, wherein the fabrication rule specifies that the inter-pattern spacing is between about 1 μm and about 30 μm and the pattern width is between about 1 μm and about 100 μm to provide the visibility level that is substantially the same as a visibility level of an indium tin oxide touch screen sensor material.

Thus, techniques described herein may provide for a sensor pattern that includes a relatively low visibility level, such as a visibility level that is substantially similar to ITO touch screen sensor materials. Moreover, techniques may determine a fabrication rule based on a visibility level that may be a function of and/or may specify an inter-patterns spacing, a pattern width, a periodicy, a pitch, a resistance, and so on. In this regard, a sensor pattern may not be visually observable to the naked eye, and may provide relatively good sheet resistivity, flexibility, conductivity, relatively low cost, relatively easy fabrication processes, and so on.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-25. (canceled)

26. A touch sensor component comprising:
a substrate; and
two or more sensor patterns formed on the substrate based on a visibility level for a touch screen sensor application, wherein the two or more sensor patterns each include a specified inter-pattern spacing and a specified pattern width to provide the visibility level, and wherein the two or more sensor patterns are each to include silver nanowire networks and are not to be observable by visual inspection.

27. The touch sensor component of claim 26, wherein the substrate includes one or more of a glass material and a polymer material.

28. The touch sensor component of claim 26, wherein the substrate and the two or more patterns are to be included in a touch sensor structure for a capacitance touch sensor.

29. The touch sensor component of claim 28, wherein the touch sensor structure is to include a portion of the two or more patterns being coupled in a dark area of a touch screen to form a subset of patterns, wherein the subset of patterns are to include a reduced resistance relative to a resistance of the portion of the two or more patterns taken individually.

30. The touch sensor component of claim 26, further including a specified pattern periodicy including a period of at least one sensor pattern, wherein the two or more sensor patterns are to include a same specified size of the specified inter-pattern spacing and a same specified size of the specified pattern width when the specified periodicy is to include a period of one sensor pattern to provide a periodical repeat of sensor patterns.

31. The touch sensor component of claim 26, wherein the visibility level is to include a specified average visibility level determined from a specified pitch for a first sensor pattern and a specified pitch for a second sensor pattern.

32. The touch sensor component of claim 31, further including a specified average pitch based on an average of variables of the specified pitch for the first sensor pattern with corresponding variables of the specified pitch for the second sensor pattern, wherein the average visibility level is to be determined based on the average pitch.

33. The touch sensor component of claim 26, further including a dummy pattern interspersed between two sensor patterns of the two or more sensor patterns.

34. The touch sensor component of claim 26, wherein the specified inter-pattern spacing is to be between about 1 μm and about 60 μm and the specified pattern width is to be between about 1 μm and about 250 μm to provide the visibility level.

35. The touch sensor component of claim 34, wherein the specified inter-pattern spacing is to be between about 1 μm and about 30 μm and the specified pattern width is to be between about 1 μm and about 100 μm to provide the visibility level that is to be substantially the same as a visibility level of an indium tin oxide touch screen sensor material.

36. A method to form and/or to implement a touch sensor component comprising:
providing a substrate;
determining a fabrication rule based at least on a visibility level for a touch screen sensor application, wherein the fabrication rule specifies an inter-pattern spacing and a pattern width to provide the visibility level; and
forming two or more sensor patterns on the substrate based on the fabrication rule, wherein the two or more sensor patterns each include silver nanowire networks and are not observable by visual inspection.

37. The method of claim 36, further including:
forming a touch sensor structure including the substrate and the two or more sensor patterns; and
utilizing the touch sensor structure in a capacitance touch sensor implementation.

38. The method of claim 36, further including coupling a portion of the two or more patterns in a dark area of a touch screen to form a subset of patterns, wherein the subset of patterns includes a reduced resistance relative to a resistance of the portion of the two or more patterns taken individually.

39. The method of claim 36, wherein the fabrication rule is to further specify a periodicy including a period of at least one sensor pattern, wherein the two or more sensor patterns include a same size of the inter-pattern spacing and a same size of the pattern width when the specified periodicy includes a period of one sensor pattern to provide a periodical repeat of sensor patterns.

40. The method of claim 36, further including:
specifying a pitch for a first sensor pattern and a pitch for a second pattern; and
determining an average visibility level from the pitch for the first sensor pattern and the pitch for the second sensor pattern.

41. The method of claim 40, further including:
averaging variables of the pitch for the first sensor pattern with corresponding variables of the pitch for the second sensor pattern to determine an average pitch; and
determining the average visibility level based on the average pitch.

42. The method of claim 36, wherein the fabrication rule specifies that the inter-pattern spacing is between about 1 μm and about 60 μm and the pattern width is between about 1 μm and about 250 μm to provide the visibility level for the touch screen sensor application.

43. The method of claim 42, wherein the fabrication rule specifies that the inter-pattern spacing is between about 1 μm and about 30 μm and the pattern width is between about 1 μm and about 100 μm to provide the visibility level that is substantially the same as a visibility level of an indium tin oxide touch screen sensor material.

44. At least one computer readable storage medium comprising one or more instructions that when executed on a computing device cause the computing device to:
provide a substrate;
determine a fabrication rule based at least on a visibility level for a touch screen sensor application, wherein the fabrication rule is to specify an inter-pattern spacing and a pattern width to provide the visibility level; and
form two or more sensor patterns on the substrate based on the fabrication rule, wherein the two or more sensor patterns are each to include silver nanowire networks and are not to be observable by visual inspection.

45. The at least one medium of claim 44, wherein when executed the one or more instructions cause the computing device to:
form a touch sensor structure that is to include the substrate and the two or more sensor patterns; and
utilize the touch sensor structure in a capacitance touch sensor implementation.

46. The at least one medium of claim 44, wherein when executed the one or more instructions cause the computing device to couple a portion of the two or more patterns in a dark area of a touch screen to form a subset of patterns, wherein the subset of patterns is to include a reduced resistance relative to a resistance of the portion of the two or more patterns taken individually.

47. The at least one medium of claim 44, wherein the fabrication rule is to further specify a periodicy including a period of at least one sensor pattern, wherein the two or more sensor patterns are to include a same size of the inter-pattern spacing and a same size of the pattern width when the specified periodicy is to include a period of one sensor pattern to provide a periodical repeat of sensor patterns.

48. The least one medium of claim 44, wherein the fabrication rule is to specify that the inter-pattern spacing is to be between about 1 μm and about 60 μm and the pattern width is to be between about 1 μm and about 250 μm to provide the visibility level for the touch screen sensor application.

49. The least one medium of claim 48, wherein the fabrication rule is to specify that the inter-pattern spacing is to be between about 1 μm and about 30 μm and the pattern width is to be between about 1 μm and about 100 μm to provide the visibility level that is to be substantially the same as a visibility level of an indium tin oxide touch screen sensor material.
